(19) United States
(12) Patent Application Publication
(10) Pub. No.: US 2008/0174642 A1
(43) Pub. Date: Jul. 24, 2008

(54) INK SUPPLYING/BLOCKING DEVICE AND IMAGE FORMING APPARATUS

(75) Inventors: Gu-hwan NA, Seoul (KR); Jin-ho Park, Giheung-gu (KR); Dong-woo Ha, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/846,148

(22) Filed: Aug. 28, 2007

(30) Foreign Application Priority Data
Jan. 23, 2007 (KR) 2007-7045

(51) Int. Cl. B41J 2/175

(52) U.S. Cl. 347/85

(57) ABSTRACT

An ink supplying/blocking device of an inkjet printer selectively supplies or blocks flow of ink of an ink tank to a channel unit in which print head is supported. The device may include a negative pressure generating unit to generate a negative pressure at the print head and thus supply a desired amount of ink to the print head through the channel unit; an ink supply tube to connect the negative pressure generating unit and the ink tank; a sealing unit to selectively open and close the ink supply tube; and a sensor to detect an operation status of the sealing unit. An image forming apparatus having the same is also disclosed.

### CROSS-REFERENCE TO RELATED APPLICATIONS

This application claims priority under 35 U.S.C. § 119(a) from Korean Patent Application No. 2007-7045, filed Jan. 23, 2007, the contents of which are incorporated herein by reference in its entirety.

### BACKGROUND OF THE INVENTION

1. Field of the Invention

The present general inventive concept relates to an ink supplying/blocking device to supply ink and selectively block supply of ink from an ink supply to a plurality of print heads and an image forming apparatus having the same.

2. Description of the Related Art

In general, an image forming apparatus, like an inkjet printer, print images on a printing medium, such as paper or cloth, by ejecting ink droplets on desired positions of the printing medium.

A conventional inkjet printer may include an ink cartridge to print an image on the printing medium while reciprocating in a direction orthogonal to a transfer direction of the paper. However, this conventional inkjet printer utilizing a reciprocating ink cartridge has a slow printing speed.

Some of the newer inkjet printers employ an ink cartridge having a plurality of print heads arranged along the entire width of the paper and print the image without requiring the ink cartridge to reciprocate, and thus the image is printed at a higher printing speed. This printer is called an array print head type inkjet printer.

In the array print head type inkjet printer, color inks should be separately supplied to each of the plurality of print heads arranged in the transverse direction of the paper. An ink tank is used to separately supply the color inks to the plurality of print heads.

A negative pressure generating unit is disposed in an ink supply path to supply inks in the ink tank to the plurality of print heads.

The negative pressure generating unit maintains a predetermined pressure so that a meniscus is formed and kept in a nozzle of the print head so that the ink is ejected by a desired amount.

The negative pressure generating unit has a valve structure which is opened and closed by an ink ejecting pressure during the printing process. If sealing around the valve structure is not perfect, the meniscus in the nozzle is broken and the ink leaks. A sealing force of the valve structure should be less than a pressure to eject the ink. Because this pressure to eject the ink is very small, increasing the sealing force is problematic.

Therefore, it is desired to prevent the ink in the ink tank from leaking through the negative pressure generating unit to the print head. More specifically, it is desired to prevent the ink in the ink tank from leaking from the ink tank to the print head via the valve structure of the negative pressure generating unit.

### SUMMARY OF THE INVENTION

The present general inventive concept provides an ink supplying/blocking device and method to allow the supply of ink as needed during a printing process and to selectively block the ink to prevent the leakage of ink at other times, for example during a standby status and an image forming apparatus having the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink supplying/blocking device of an inkjet printer which selectively supplies and blocks ink of an ink tank to a print head. The print head may be supported within a channel unit. The ink supplying/blocking device may include a negative pressure generating unit to generate a negative pressure at the print head to thus supply a desired amount of ink to the print head through the channel unit; an ink supply tube to connect the negative pressure generating unit and the ink tank; a sealing unit to selectively open and close the ink supply tube; and a sensor to detect an operation status of the sealing unit.

The sealing unit may include a cam member movable between a first position in which the ink supply tube is deformed to block a flow of ink and a second position in which the deformed ink supply tube is restored to allow a flow of ink; a shaft which is coupled with the cam member; and a driving unit to selectively rotate the shaft so that the cam member may be moved between the first and second positions.

The driving unit may include a gear which is connected with the shaft and a driving motor to rotate the gear.

The sealing unit may include a pressing member which is movably disposed between the cam member and the ink supply tube so as to press the ink supply tube due to the force of the cam member when the cam member is moved to the first position.

The sensor may include an encoder which is connected with the driving motor and a reading unit to read a value of the encoder.

The sensor may include a plurality of marks which are formed at or on the gear and a mark detecting sensor which detects the marks when the gear is rotated to determine the position of the cam member.

The ink supplying/blocking device may further include a filter which is disposed between the ink tank and the negative pressure generating unit so as to filter the ink moved to the ink supply tube.

The foregoing and/or other aspects and utilities of the present general inventive concept may be achieved by providing an image forming apparatus including an ink tank; a channel unit which supports a plurality of print heads and supplies ink to each of the print heads; a negative pressure generating unit to generate a negative pressure at the print head and thus supply a desired amount of ink to the print head through the channel unit; an ink supply tube to connect the negative pressure generating unit and the ink tank; a sealing unit to selectively open and close the ink supply tube; and a sensor to detect an operation status of the sealing unit.

The sealing unit may include a cam member which is moved between a first position in which the ink supply tube is deformed to block a flow of ink and a second position in which the deformed ink supply tube is restored to allow the flow of ink; a shaft which is coupled with the cam member; and a driving unit which selectively rotates the shaft so that the cam member may be moved between the first and second positions.

The driving unit may include a gear which is connected with the shaft and a driving motor to rotate the gear.

The sealing unit may further include a pressing member which is movably disposed between the cam member and the ink supply tube so as to press the ink supply tube due to the force of the cam member when the cam member is moved to the first position.

The sensor may include an encoder which is connected with the driving motor and a reading unit to read a value of the encoder.

The sensor may include a plurality of marks which are formed at or on the gear and a mark detecting sensor which detects the marks when the gear is rotated to determine the position of the cam member.

The foregoing and/or other aspects and utilities of the present general inventive concept may be achieved by a method of minimizing ink leakage in a printer, the printer including an ink tank to provide ink to a negative pressure generating unit by an ink passage, the method including closing the ink passage to prevent the flow of ink along the ink passage during a period when a printing operation is not desired; and opening the ink passage to allow ink to flow from the ink tank to the negative pressure generating unit along the ink passage when flow of ink is desired.

The foregoing and/or other aspects and utilities of the present general inventive concept may be achieved by providing a printer including a print head; an ink tank; an ink passage in fluid communication with the ink tank and the print head to pass ink from the ink tank to the print head; and a blocking element to block the flow of ink along the ink passage only when a printing operation is not desired

The foregoing and/or other aspects and utilities of the present general inventive concept may also be achieved by further providing a filter which is disposed between the ink tank and the negative pressure generating unit so as to filter the ink provided to the ink supply tube.

### BRIEF DESCRIPTION OF THE DRAWINGS

These and/or other aspects, utilities and advantages of the present general inventive concept will become apparent and more readily appreciated from the following description of the embodiments, taken in conjunction with the accompanying drawings of which:

FIGS. 1 and 2 are perspective views illustrating an image forming apparatus according to an embodiment of the present general inventive concept;

FIG. 3 is a perspective view illustrating a channel unit of FIG. 1 according to an embodiment of the present general inventive concept;

FIGS. 4A and 4B are views illustrating an embodiment with an ink supply tube that is opened; and

FIGS. 5A and 5B are views illustrating an embodiment with an ink supply tube that is closed.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

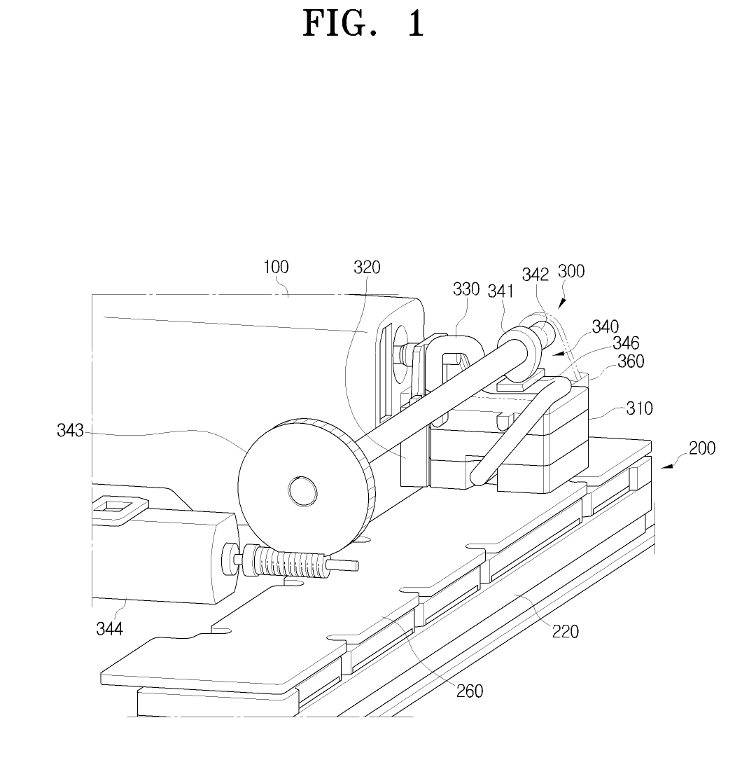

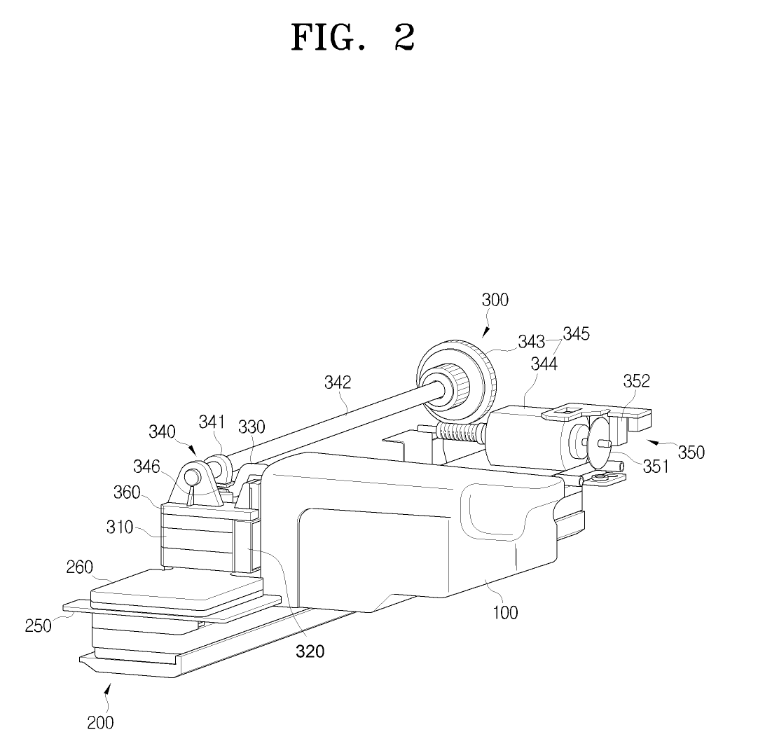

FIGS. 1 and 2 illustrate an image forming apparatus according to an embodiment of the present general inventive concept. This embodiment includes an ink tank 100, a channel unit 200 which supports a plurality of print heads (not illustrated) at a lower side thereof and an ink supplying/blocking device 300 to selectively supply and block ink from the ink tank 100 to the channel unit 200.

An ink of a desired color is stored in the ink tank 100, and a plurality of ink tanks 100 for each color such as yellow, magenta, cyan and black are provided. That is, although only one ink tank 100 is illustrated in FIGS. 1 and 2, a plurality of ink tanks for each color can be provided. The ink tank 100 may be an expendable item which is removably installed to a main body (not illustrated) of the image forming apparatus to allow replacement with a new ink tank when needed.

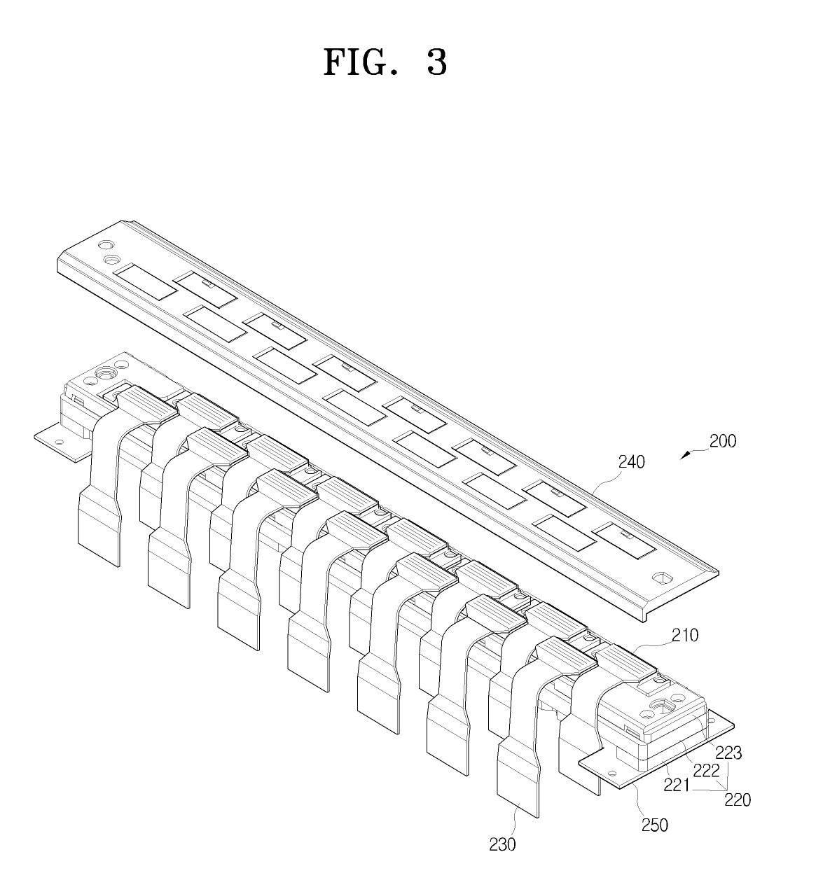

As illustrated in FIG. 3, the channel unit 200 has a plurality of print heads 210 arranged in two rows at a lower side thereof and a stacked channel member 220. The print heads 210 are arranged along a transverse direction of printing paper in two rows. Each of the print heads 210 has a nozzle to eject the ink supplied for each color through the channel member 220. An FPC (flexible printed circuit) 230 having a head chip is connected to a nozzle surface of the print head 210.

The channel member 220 has a stacked structure in which first, second and third channel member parts 221, 222 and 223 are stacked in turn. Each of the channel member parts 221, 222 and 223 of the channel member 220 function to receive the ink from the ink tank 100 for each color through a negative pressure generating unit 310 (discussed below) and then supply the ink to corresponding print heads 210, arranged as illustrated in two rows. Although three channel member parts 221, 222 and 223 are stacked in this embodiment, the number of channel member parts may be further increased or decreased.

A cover member 240 is coupled to the channel member 220 with apertures to expose the print heads 210. A reinforcement plate 250 is coupled to the channel member 220 to prevent deformation of the channel member 220. The reinforcement plate 250 may be made of a metallic material. As illustrated in FIGS. 1 and 2, the reinforcement plate 250 is supported by a supporting frame 260.

The ink supplying/blocking device 300 of this embodiment includes a negative pressure generating unit 310, a filter 320, an ink supply tube 330, a sealing unit 340 and a sensor 350. As will be apparent to the reader, the ink supplying/blocking device 300 may be embodied by other structures to perform the intended operations described below.

The negative pressure generating unit 310 generates a negative pressure between the print head 210 and the channel member 220 so as to prevent the ink from leaking through the print head 210. The negative pressure generating unit 310 has a valve structure therein, which is opened by ink pressure during ejection to the print head 210 so that the ink is supplied as desired. It is not intended that the present general inventive concept is limited to any particular construction of the negative pressure generating unit 310, and since this technology is well-known, its detailed description is omitted.

The filter 320 is connected to an ink outlet of the ink tank 100. Filter 320 filters the ink supplied from the ink tank 100 to the negative pressure generating unit 310 to remove impurities, bubbles and so on.

The ink supply tube 330 connects the filter 320 and the negative pressure generating unit 310. The ink filtered by the filter 320 is supplied through the ink supply tube 330 to the negative pressure generating unit 310. The ink supply tube 330 is made of a flexible material, which can be deformed by an external force to have a desired width.

One end of the ink supplying tube 330 is connected to an upper portion of the filter 320, and the other end is connected to a lower portion of the negative pressure generating unit 310 via an upper portion of the negative pressure generating unit 310.

The sealing unit 340 includes a cam member 341, a shaft 342, a pressing member 346 and a driving unit 345.

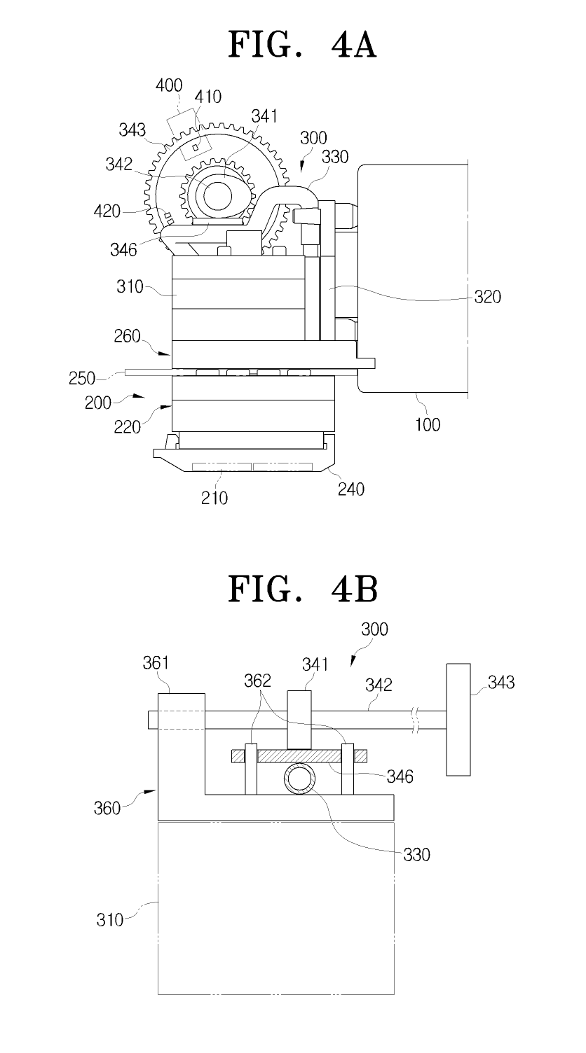

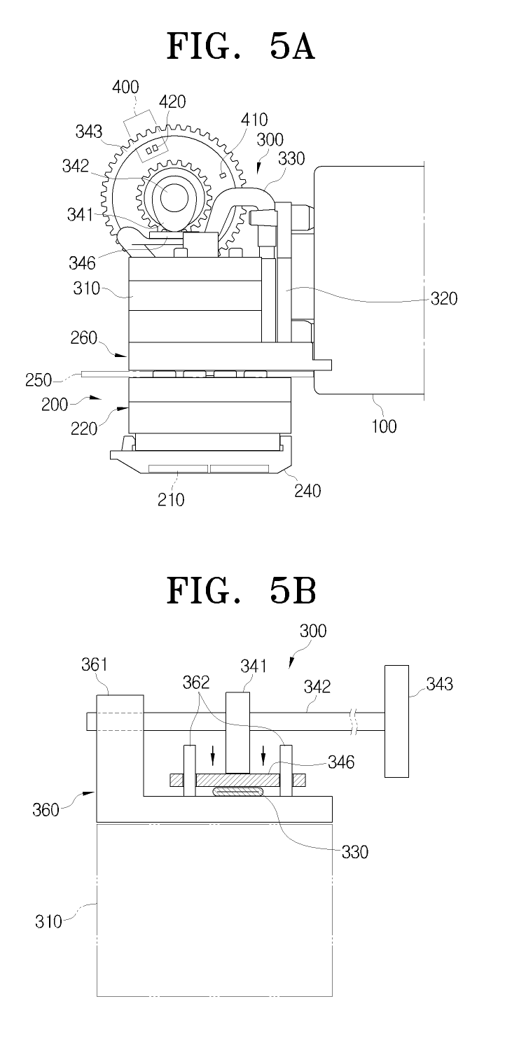

The cam member 341 is coupled to the shaft 342 and may be rotated between a first position and a second position. In the first position, as illustrated in FIGS. 5A and 5B, a protruding portion of the cam member 341 protrudes towards the ink supply tube 330 so that the ink supply tube 330 is pressed and deformed and a flow of ink is blocked. In the second position, as illustrated in FIGS. 4A and 4B, the protruding portion of the cam member 341 is moved away from the ink supply tube 330, and thus the deformed ink supply tube 330 is restored to its original state so that the ink may flow.

The cam member 341 may directly press and deform the ink supply tube 330. However, it is possible that the cam member 341 presses and deforms the ink supply tube 330 via the pressing member 346. As illustrated in FIGS. 4A to 5B, the pressing member 346 is disposed between the ink supply tube 330 and the cam member 341.

In this embodiment, a supporting block 360 is provided at an upper side of the negative pressure generating unit 310. Shaft 342 is rotatably supported by a shaft supporting portion 361 of the supporting block 360. A pair of guide bosses 362 is provided to the supporting block 360 to guide the pressing member 346 upward and downward. The ink supply tube 330 is disposed to pass between the guide bosses 362. Therefore, when the pressing member 346 is pressed by the cam member 341, the pressing member 346 descends along the guide bosses 362 and presses and deforms the ink supply tube 330, as illustrated in FIG. 5B. More specifically, the ink supply tube 330 is pressed and deformed so as to block the supply of ink. Furthermore, a secure seal is created between the ink tank 100 and the negative pressure generating unit 310. Then, as illustrated in FIGS. 4A and 4B, when the cam member 341 returns to its original position, the ink supply tube 330 is restored to its original status to allow the ink to be supplied again.

The driving unit 345 selectively rotates the shaft 342 so that the cam member 341 can be moved between the first and second positions. The driving unit 345 includes a gear 343 coupled to the shaft 342 and a driving motor 344 to drive the gear 343. The gear 343 engages with a driving gear provided at the driving shaft of the driving motor 344. Modifications of the driving unit 345 and/or the elements of the driving unit (gear 343, motor 344 and driving gear) will be obvious to the reader. In this embodiment, the driving gear of the driving motor 344 may be designed in accordance with an installation position of the driving motor 344 and the type of gear 343 chosen. And in an embodiment, the driving motor 344 is a bidirectional motor.

Sensor 350 detects the operational status of the sealing unit 340. Referring to FIG. 2, the sensor 350 of this embodiment includes an encoder 351 connected to the driving shaft of the driving motor 344 and a reading unit 352 to read angle scale information of the encoder 351 to measure rotation. The encoder 351 is rotated the same amount as the driving shaft of the driving motor 344. The reading unit 352 is coupled to a supporting member which is in turn coupled to the driving motor 344. The reading unit 352 reads the angle scale information of encoder 351 to determine the rotational status of the encoder 351. The information read by the reading unit 352 is transferred to a control unit (not illustrated). Based on the information transferred from the reading unit 352, the control unit determines the number of rotations of the driving shaft of the driving motor 344 and/or the angular position of the driving shaft of the driving motor 344 in order to control the motor 344 to drive the cam member 341 until the cam member 341 is completely moved to either of the first and second positions.

Another example of a sensor is illustrated in FIGS. 4A and 5A in connection with a further embodiment. As illustrated, first and second marks 410 and 420 are provided on the gear 343. A mark detecting sensor 400 to detect the marks 410 and 420 is also provided.

The first and second marks 410 and 420 are formed on a side surface of the gear 343 and are spaced apart from each other at a desired angle (with the axis of rotation of the gear 343 being the vertex of the angle). Specifically, the first and second marks 410 and 420 are positioned along a desired angle corresponding to the angular rotation of gear 343 necessary for the gear 343 to move the cam member 341 from the first position and the second position. Thus, the detecting sensor 400 can determine the position of the cam member 341 upon detecting the first and second marks 410 and 420. The detecting sensor 400 is connected with the control unit to transfer a detected signal to the control unit. Therefore, the control unit controls the driving of the driving motor 344 on the basis of the transferred signal.

Hereinafter, the effect of the image forming apparatus according to the present general inventive concept will be described. While this description corresponds to the embodiment of FIGS. 4A, 4B, 5A and 5B, it is equally pertinent to the embodiment of FIGS. 1 and 2, as will be apparent to the reader.

When a printing operation is not being performed, as shown in FIGS. 5A and 5B, the cam member 341 is placed at the first position. That is, the protruded portion of the cam member 341 presses the pressing member 346 and thus, through the pressing member 346, the ink supply tube 330. Then, the ink supply tube 330 is deformed so that the ink can not pass. If the ink supply tube 330 is blocked, the ink tank 100 is sealed from the negative pressure generating unit 310, and accordingly the ink can no longer pass from the ink tank 100 to the negative pressure generating unit 310. Therefore, the ink is prevented from leaking through to the print head when the negative pressure in the negative pressure generating unit 310 is unstable, for example, when the inkjet printer is inclined to one side, or an impact is applied to the printer. In an embodiment, the ink supplying/blocking device is operated by the controller to pinch the ink supply tube 330 so that the ink cannot pass just prior to turning off the image forming apparatus or putting the image forming apparatus in a standby mode. The ink supply tube 330 maintains its pinched status until the image forming apparatus is turned back on or taken out of standby mode. In another embodiment, the ink supplying/blocking device is operated by the controller to pinch the ink supply tube 330 so that the ink cannot pass at any time a print job is not pending for the image forming apparatus. In a further embodiment, the ink supply tube 330 may be released from its pinched status at all times a print job is pending. As used in this application, a print job is considered pending if an external device has requested a print operation and the print operation has not been completed. Thus, in a further embodiment, the ink supply tube 330 may be released from its pinched status at all times a print job is pending, except when the print job is interrupted by an error, for example, by an-out-of paper error, or out-of-ink error.

When printing is desired, the control unit drives the driving motor 344, based on the signal transferred from the sensor 350, to place the cam member 341 in the second position, as illustrated in FIGS. 4A and 4B. Thus, the external force applied to the ink supply tube 330 is released and the ink supply tube 330 is restored to its original status. Therefore, the ink from the ink tank 100 can be supplied to the negative pressure generating unit 310 through the ink supply tube 330, and the printing operation is normally performed.

According to the ink supplying/blocking device and the image forming apparatus of the various embodiments of the present general inventive concept, as described above, the ink supply tube can be selectively opened and closed. By sealing the ink supply when the printing operating is not performed, ink is prevented from leaking through to the print head.

Also, the print head and other parts are prevented from being contaminated by the leakage of ink.

Further, the ink is prevented from leaking even when there is an undesirable inclination of the cartridge or printer or when the printer receives an external impact.

In addition, by controlling the driving motor using a sensor, the closing and opening of the ink supply tube can be precisely controlled, thereby increasing reliability of the apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents. Terms in the claims should be given their broadest interpretation consistent with the general inventive concept as set forth in this description. For example, the terms “coupled” and “connect” (and derivations thereof) are used to connote both direct and indirect connections/couplings. As another example, “supply” and “block” connote both direct and indirect supply/blocking. Claims are not intended to be interpreted under 112 sixth paragraph unless the phrase “means for” and an associated function appear in a claim and the claim fails to recite sufficient structure to perform such function.

1. An ink supplying/blocking device of an inkjet printer which selectively supplies or blocks the flow of ink of an ink tank to a print head, comprising:
a negative pressure generating unit to generate a negative pressure at the print head to supply ink to the print head;
an ink supply tube to connect the negative pressure generating unit and the ink tank;
a sealing unit to selectively open and close the ink supply tube; and
a sensor to detect an operation status of the sealing unit.

2. The ink supplying/blocking device of claim 1, wherein the sealing unit comprises:
a cam member which moves between a first position corresponding to a deformation of the ink supply tube to block a flow of ink and a second position in which the ink supply tube is at least partially restored to allow the flow of ink;
a shaft which is coupled with the cam member; and
a driving unit which selectively rotates the shaft so that the cam member is moved between the first and second positions.

3. The ink supplying/blocking device of claim 2, wherein the driving unit comprises:
a gear which is connected with the shaft; and
a driving motor to rotate the gear.

4. The ink supplying/blocking device of claim 2, wherein the sealing unit further comprises a pressing member which is movably disposed between the cam member and the ink supply tube so as to press the ink supply tube due to the force of the cam member when the cam member is at the first position.

5. The ink supplying/blocking device of claim 3, wherein the sensor comprises:
an encoder which is connected with the driving motor; and
a reading unit to read a value of the encoder.

6. The ink supplying/blocking device of claim 3, wherein the sensor comprises:
a plurality of marks which are formed at, on or within the gear; and
a mark detecting sensor which detects the marks when the gear is rotated to determine the position of the cam member.

7. The ink supplying/blocking device of claim 1, further comprising a filter which is disposed between the ink tank and the negative pressure generating unit so as to filter the ink provided to the ink supply tube.

8. An image forming apparatus comprising:
an ink tank;
a channel unit which supports a plurality of print heads to supply ink to the print heads;
a negative pressure generating unit to generate a negative pressure at the print heads and to supply ink to the print heads through the channel unit;
an ink supply tube to connect the negative pressure generating unit and the ink tank;
a sealing unit to selectively open and close the ink supply tube; and
a sensor to detect an operation status of the sealing unit.

9. The image forming apparatus of claim 8, wherein the sealing unit comprises:
a cam member which is moved between a first position to apply pressure to deform the ink supply tube to block a flow of ink and a second position in which the ink supply tube is at least partially restored to allow the flow of ink;
a shaft which is coupled with the cam member; and
a driving unit which selectively rotates the shaft so that the cam member is moved between the first and second positions.

10. The image forming apparatus of claim 9, wherein the driving unit comprises:
a gear which is connected with the shaft; and
a driving motor to rotate the gear.

11. The image forming apparatus of claim 9, wherein the sealing unit further comprises a pressing member which is movably disposed between the cam member and the ink supply tube so as to press the ink supply tube due to the force of the cam member when the cam member is at the first position.

12. The image forming apparatus of claim 10, wherein the sensor comprises:
an encoder which is connected with the driving motor; and
a reading unit to read a value of the encoder.

13. The image forming apparatus of claim 10, wherein the sensor comprises:
a plurality of marks which are formed at, on or within the gear; and
a mark detecting sensor which detects the marks when the gear is rotated to determine the position of the cam member.

14. The image forming apparatus of claim 8, further comprising a filter which is disposed between the ink tank and the negative pressure generating unit so as to filter the ink provided to the ink supply tube.

15. A method of minimizing ink leakage in a printer, the printer including an ink tank to provide ink to a negative pressure generating unit by an ink passage, the method comprising:
closing the ink passage to prevent the flow of ink along the ink passage during a period when a printing operation is not desired; and
opening the ink passage to allow ink to flow from the ink tank to the negative pressure generating unit along the ink passage when flow of ink is desired.

16. The method of claim 15, wherein the ink passage is a flexible tube, and step (a) includes pinching the flexible tube to seal a passage through the tube.

17. The method of claim 16, wherein the opening of the ink passage includes releasing an applied pressure to the flexible tube, and the flexible tube at least partially restores toward its original shape by self restoration.

18. The method of claim 15, further comprising:
filtering the ink after the ink leaves the ink tank and before the ink reaches the negative pressure generating unit.

19. The method of claim 18, wherein a filter is directly connected to the ink tank to receive ink, and directly connected to the ink passage to provide ink and the filtering of the ink includes filtering the ink with the filter.

20. The method of claim 15, wherein the closing of the ink passage includes closing the ink passage at a time prior to turning off the printer, and further comprising:
turning off the printer and maintaining closure of the passage during the entire period when the printer is off.

21. The method of claim 15, wherein the opening of the ink passage includes opening the ink passage to allow ink to flow from the ink tank to the negative pressure generating unit along the ink passage whenever a print job is pending at the printer.

22. The method of claim 15, wherein the opening of the ink passage includes opening the ink passage to allow ink to flow from the ink tank to the negative pressure generating unit along the ink passage whenever a print job is pending at the printer except when a print job is interrupted by an error.

23. A printer comprising:
a print head;
an ink tank;
an ink passage in fluid communication with the ink tank and the print head to pass ink from the ink tank to the print head; and
a blocking element to block the flow of ink along the ink passage only when a printing operation is not desired.

24. The printer of claim 23, wherein the ink passage is a flexible tube and the blocking element exerts a force upon the flexible tube to pinch the flexible tube.

25. The printer of claim 24, wherein the blocking element includes:
a motor having a driving shaft;
a cam to rotate in response to the rotation of the driving shaft and positioned to apply a force upon the flexible tube to pinch the flexible tube when the cam is in a first position, and to release the pinch of the flexible tube when the cam is in a second position.

26. The printer of claim 25, wherein the blocking element further includes:
a driving gear directly coupled to the driving shaft of the motor to rotate in unison with the driving shaft;
a second gear to engage with the driving gear to receive a driving force of the driving motor through the driving gear;
a second shaft directly coupled with the second gear to rotate in unison with the second gear; and
wherein the cam is directly coupled to the second shaft.

27. The printer of claim 25, further comprising:
a sensor to detect the position of the cam; and
a controller to operate the motor as a function of information received from the sensor.

28. The printer of claim 27, wherein the sensor detects the position of the cam by detecting the position of a mechanical element used to transfer force from the motor to the cam.

29. The printer of claim 28,
wherein the blocking element further includes a shaft upon which the cam is mounted, and a gear attached to the shaft to transfer a driving force to the cam via the shaft, and
wherein the sensor detects the position of the cam by detecting markings at, on or within the gear.

30. The printer of claim 28,
wherein the motor includes an encoder attached to a driving shaft, and
wherein the sensor detects the position of the cam by reading the encoder.
